(19) United States
(12) Patent Application Publication
(10) Pub. No.: US 2023/0361455 A1
(43) Pub. Date: Nov. 9, 2023

(54) MULTI-RANGE SINGLE LAYER ANTENNA FOR MULTICHANNEL COMMUNICATION AND NAVIGATION SYSTEMS

(71) Applicant: GENERAL MICROWAVE LLC, Moscow (RU)

(72) Inventors: Aleksandr Sergeevich Kukharenko, Moscow (RU); Ruslan Varisovich Shaimardanov, Moscow (RU)

(21) Appl. No.: 17/613,513

(22) PCT Filed: Apr. 28, 2021
(86) PCT No.: PCT/RU2021/000179

§ 371 Date: Nov. 3, 2022

(51) Int. Cl. H01Q 1/38

(52) U.S. Cl. CPC H01Q 1/38

(57) ABSTRACT

The technical solution relates to ultra-high frequencies (UHF) electronics and is a passive device, in particular, a multi-range microstrip antenna of complex design. The antenna construction (FIG. 1) is a dielectric substrate (1) with a dielectric capacity of at least 2, mounted on a conductive metal screen (2), on the upper side of which external (3) and internal (4) radiating elements of the disk or ring form and made of a conductive material, at least two in number, are located in a coplanar concentric way. The radiating elements are powered by supply probes (5 and 6), that have direct ohmic contact with radiating elements. The inner edge of the outer and all inner radiating elements, except for the central one, is connected to a common conductive screen by a metal ring (7). The antenna operates the following way. The signal from the supply probe (5 and 6) is fed to the emitting element (3, 4), the dimensions of which are determined so that, together with the dielectric substrate (1) and the conductive screen (2), it would form a resonant circuit matching the impedance of the open space. Subject to that, a signal in the form of an electromagnetic wave is emitted from the outer edge of the radiating element into the surrounding space. Therefore, the proposed design made it possible to provide separate high-precision signal reception in different ranges by one antenna element by providing isolation between the radiating elements, reducing the overall antenna dimensions and eliminating the parasitic effect of mirror currents.

### TECHNICAL FIELD

The technical solution relates to microstrip antennas and can be used as a receiving or emitting antenna element with a cardioid radiation pattern.

### BACKGROUND

Currently, to ensure the reception of signals in both L1 and L2 bands, the so-called “stacked” circuit scheme (patent RU2315398C1 “Multiband microstrip stacked circuit type antenna”, published on 20.01.2008) is applied at the stage of developing the antenna elements for satellite navigation systems. Essentially, this design represents two antenna elements located one above the other. The disadvantages of this type of antenna elements design, in addition to increasing the overall dimensions, include the low manufacturability of the design and a significant decrease in the stability of the phase center of the antenna element in all operating ranges, which is due to the spatial separation of the ground planes. A significant difference of the solution proposed in the application is that the antenna elements of the L1 and L2 bands are located on the same dielectric substrate in the same plane and have a common ground surface, which contributes to an increase in the manufacturability of the design and a decrease in the instability of the phase center.

The prototype of the proposed design should include the design of the multi-resonant antenna element, outlined in the U.S. Pat. US6876328B2, published on 05.04.2005. Radiating elements in this design are also located in the same plane and have a common substrate. But they are powered by common transmission lines that are capacitively connected with radiating elements. In the proposed design, the emitting elements are powered independently using probes that have direct ohmic contact with the emitting elements, which contributes to an increase in the isolation between the operating ranges. Besides that, the external radiating element is additionally grounded in order to increase the isolation.

### SUMMARY

The solution is aimed at producing a compact antenna element that provides independent signal reception or transmission in different frequency ranges.

The technical outcome of the proposed solution is the reduction of overall antenna dimensions and allowing of separate high-precision reception of different range signals by one antenna element.

The specified technical outcome is achieved by putting radiating elements in one plane and the use of independent power supply points in the antenna design.

The antenna contains external and internal radiating elements that are located concentrically in the same plane on a common dielectric substrate, above a common screen and have separate independent power supply points, while the external radiating element additionally has direct ohmic contact with a common screen in several spots.

### DESCRIPTION OF DRAWINGS

The invention is understood better from the non-restrictive description, which is given with reference to the accompanying schematics that show:

FIG. 1. Antenna construction.

FIG. 2. Internal radiating element supply probe reflection coefficient.

FIG. 3. External radiating element supply probe reflection coefficient.

FIG. 4. Isolation between the internal and external radiating elements supply probes.

1 - common dielectric substrate; 2 - common screen; 3 - external radiating element; 4 - internal radiating element; 5 - supply probe connections points (power supply points) of the external radiating element; 6 -supply probe connections points (power supply points) of the internal radiating element; 7 - conductive ring providing contact between the external radiating element and a common screen.

### DETAILED DESCRIPTION

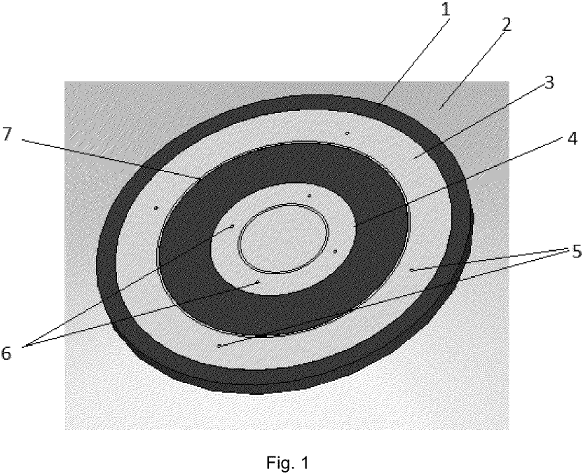

The antenna construction (FIG. 1) is a dielectric substrate (1) with a dielectric capacity of at least 2, mounted on a conductive metal screen (2), on the upper side of which external (3) and internal (4) radiating elements of the disk or ring form and made of a conductive material, at least two in number, are located in a coplanar concentric way. The radiating elements are powered by supply probes (5 and 6), that have direct ohmic contact with radiating elements and no contact either with each other or with common conductive screen.

The number of supply probes on each radiating element is the same, and the probes on the outer and inner radiating elements are located strictly on the lines passing through the concentric center. The inner edge of the outer and all inner radiating elements, except for the central one, is connected to a common conductive screen by a metal ring (7). The dimensions of each radiating element are determined so as to provide radiation at the required operating frequency.

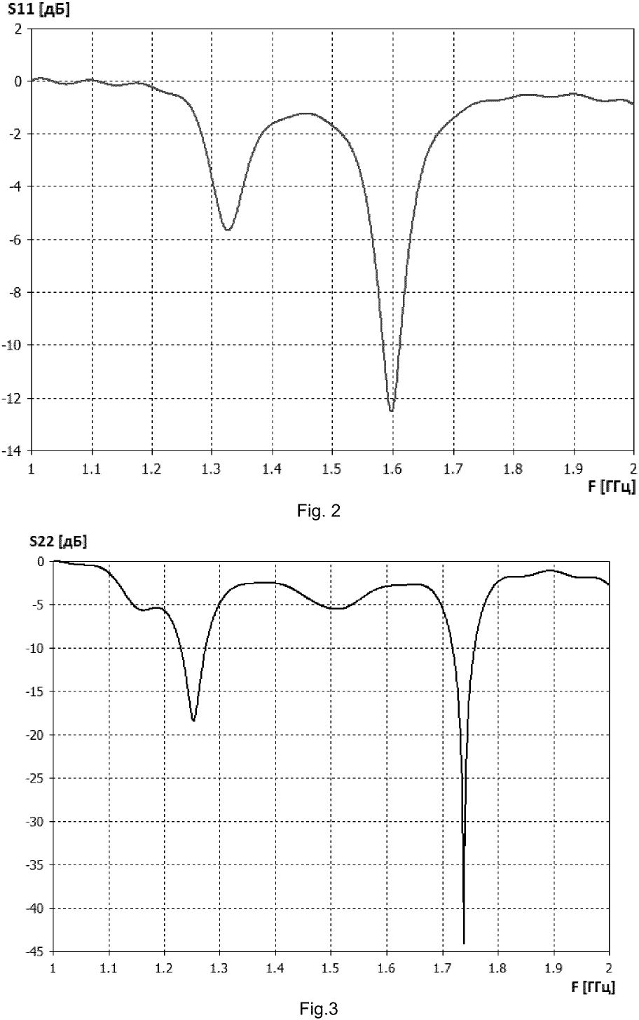

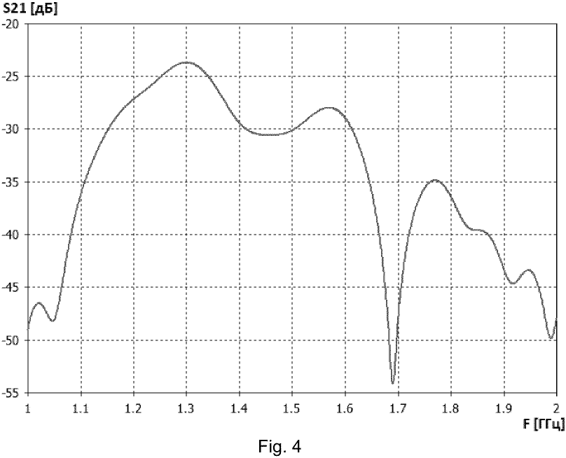

The antenna operates the following way. The signal from the supply probe (5 and 6) is fed to the emitting element (3, 4), the dimensions of which are determined so that, together with the dielectric substrate (1) and the conductive screen (2), it would form a resonant circuit matching the impedance of the open space. Subject to that, a signal in the form of an electromagnetic wave is emitted from the outer edge of the radiating element into the surrounding space. Since the radiating elements have different sizes, each of them will emit and receive signals at those frequencies at which the resonant circuit formed by them is matched with the surrounding space. Thus, in the presented example, the inner radiating element receives and emits signals in the L1frequency range (FIG. 2), whereas the external - in theL2 range (FIG. 3). All the while, since there is no direct contact between the power supply points of different radiating elements, each probe allows reading only the signal of its operating range from the radiating element. Additional isolation of the radiating elements is provided by conductive rings (7) connecting the inner edges of the external resonant elements with a common conductive screen. This allows to eliminate the parasitic capacitive connection between adjacent radiating elements. Those measures together have led to the isolation between the bands in the proposed antenna design being at least 20 dB (FIG. 4). The location of the radiating elements in coplanar way above the common conducting screen leads to a reduction in the overall antenna height and to a significant reduction in the parasitic influence of mirror currents, which in turn allows achieving high stability of the vase centers of the radiating elements, which is necessary in precision navigation systems.

Therefore, the proposed design made it possible to provide separate high-precision signal reception in different ranges by one antenna element by providing isolation between the radiating elements, reducing the overall antenna dimensions and eliminating the parasitic effect of mirror currents.

1. An antenna containing external and internal radiating elements, which are located concentrically in the same plane on a common dielectric substrate, above a common screen and have separate independent power supply points.

2. An antenna containing external and internal radiating elements, which are located concentrically in one plane on a common dielectric substrate, above a common screen and have separate independent power supply points, while the external radiating element additionally has direct ohmic contact with a common screen in several spots.
